(19) United States
(12) Patent Application Publication
(10) Pub. No.: US 2007/0109481 A1
(43) Pub. Date: May 17, 2007

(54) Display device and display unit comprising the same

(75) Inventors: Kouji Mimura, Tokyo (JP); Ken Sumiyoshi, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/598,714

(22) Filed: Nov. 14, 2006

(30) Foreign Application Priority Data
Nov. 15, 2005 (JP) 2005-330660

(51) Int. Cl. G02F 1/1343

(52) U.S. Cl. 349/143

(57) ABSTRACT

The display device is divided into a low scattering region and a high scattering region. The display device is disposed on a backlight, thereby constituting a display unit with the display device and the backlight. The low scattering region and the high scattering region can be driven separately from each other. That is, it is a structure in which at least a part of the region in the display device has a scattering power that is different from that of the other region, and each region can be driven independently.

### BACKGROUND OF THE INVENTION

1. Field of the Invention

The present invention relates to a display device such as LCD, and to a display unit. In particular, it relates to a display device and a display unit which are capable of changing the range of view angles in accordance with the use state thereof.

2. Description of the Relates Art

Liquid crystal display devices are widely employed for portable information terminals (portable telephones, notebook computers, etc.) because of their characteristics, such as being thin-type, light-weight, low power consumption, etc. A conventional TN system largely depends on the view angle, so that there is such an issue that an image may be inversed or may not be viewed from a certain direction. Recently, however, a wide visual field that is as good as CRT, which has no view angle dependency for any angles, has been achieved and spread due to developments of a film that compensates the view angle, an in-plane switching system (IPS system) that uses lateral electric fields, and a vertical alignment system (VA system) that uses the vertical orientation.

Meanwhile, portable information terminals are literally excellent in terms of the portability and are used under various environments. For example, there are various use environments such as a circumstance where a display of an information terminal is shared by a plurality of members at a meeting, and a circumstance where information is inputted in a public place such as on a train or airplane. From the viewpoint of the users, it is preferable for the portable information terminal, i.e. the liquid crystal display device, to have wider view angles as much as possible under the former use environment, so that it can be shared by a plurality of members. Under the latter use environment, however, if the view angle of the liquid crystal display device is too wide, others can peep at the display. Thus, the integrity and privacy of the information cannot be protected. Therefore, the view angle under such use environment is desirable to be kept within the range that can be viewed only by the user.

There has been strongly desired to develop a display unit that is capable of freely switching the view angle of the liquid crystal display device between the wide vision display and narrow vision display in accordance with the use environments. For example, Patent Literatures 1 and 2 propose a liquid crystal display unit that meets this demand.

First, the liquid crystal display unit disclosed in Japanese Unexamined Patent Publication 11-174489 will be described. This liquid crystal display unit is constituted with two polarizing plates, and a display liquid crystal device and a phase-difference-control liquid crystal device arranged one over another between those polarizing plates. When a voltage is not applied to the phase-difference-control liquid crystal device, it functions as a wide vision display due to the view angle dependency of the display liquid crystal device. Meanwhile, when a voltage is applied to the phase-difference-control liquid crystal device, it becomes a narrow vision display, because the phase difference of the phase-difference-control liquid crystal device is superimposed on the phase difference of the display liquid crystal device. In other words, the phase difference is controlled by applying or not applying the voltage to the phase-difference-control liquid crystal device. With this, the view angle property of the liquid crystal unit is switched between the wide view field and narrow view field.

Next, the liquid crystal display unit disclosed in Japanese Unexamined Patent Publication 2003-295160 will be described. In this liquid crystal display unit, a single pixel is constituted with a plurality of sub-pixels that can be driven separately from each other, and it is provided with a plurality of gradation tables so that a different gradation curve can be displayed by each sub-pixel. With this, the wide view field and narrow view field can be switched by providing different gradation curves for each sub-pixel and adjusting the gradation distortion generated by each gradation curve.

However, the above-described related arts face the following issues.

The liquid crystal display unit disclosed in Japanese Unexamined Patent Publication 11-174489 has a structure in which a phase-difference-control liquid crystal panel is additionally provided for narrowing the view field. Accordingly, it becomes thicker than the conventional liquid crystal display unit is for the thickness of the phase-difference-control liquid crystal panel, which becomes an obstacle for reducing the thickness and weight. Furthermore, when the thickness of the phase-difference-control liquid crystal panel is increased, there generates a parallax in the display, thereby deteriorating the display quality.

In addition, it is difficult to obtain a sufficient shielding property for a wide angle, since the narrow view field is achieved by controlling the phases of the liquid crystal molecules. That is, for shielding the light by controlling the phases of the liquid crystal molecules, the voltage to be applied to the phase-difference-control liquid crystal panel is determined with a certain angle as a reference. In that case, although the shielding property can be obtained at a set angle, the optimum phase difference differs for the wider angle side and narrower angle side than the set angle. Thus, inversion of the display, light leakage or the like may be caused, so that it can hardly be considered as narrow vision display.

In the liquid crystal display unit disclosed in Japanese Unexamined Patent Publication 2003-295160, a pixel is constituted with a plurality of sub-pixels that are driven separately from each other to display different gradation curves for each sub-pixel. With this, the wide view field and the narrow view field are switched. Even though the display unit utilizes the different gradation curves, it still utilizes the gradation curve of the same liquid crystal molecules, i.e. the view angle dependency, for performing the control. Thus, there is a limit in the variation range of the view angles, and the narrow view field achieved at the time of narrow vision display is insufficient.

### SUMMARY OF THE INVENTION

The object of the present invention therefore is to provide a display device and the like with a high display quality, which are capable of switching the narrow vision display and wide vision display, without increasing the thickness of the entire device.

The display device according to the present invention comprises a plurality of pixels having different view angles and a plurality of electrodes for driving the each pixels independently. The “electrodes” mentioned herein may be in any forms as long as they are electrodes that can drive the pixels, and the term includes the part that is directly in contact with the pixel as well as the wiring part.

The plurality of pixels can be divided into three types in accordance with the view angles thereof, such as wide view angle, middle view angle, and narrow view angle. The plurality of electrodes are divided for those three kinds. That is, the pixel of the wide view angle is driven by the electrode exclusively used therefore. It is the same for the pixels of the middle view angle and narrow view angle. With this, the pixels of each view angle can be driven independently, so that it is possible to switch the display in accordance with the view angles. In that case, the display quality at each view angle can be improved compared to the related art that utilizes the phase difference and the gradation curve. This can be achieved because the pixels whose view angles are designed in advance are switched, so that the same display quality as the case of the display device of a single view angle can be obtained. Further, it is unnecessary to pole up two display devices, so that the there is no increase in the thickness of the entire display device. Needless to say, in accordance with the view angles, the plurality of pixels may be of three kinds as described above, or may be of four kinds or more in addition to the case of two kinds that will be described later.

The display device may be characterized in that the plurality of pixels comprise a first pixel having a first view angle and a second pixel having a second view angle which is different from the first view angle; and the plurality of electrodes comprise a first pixel driving electrode for driving the first pixel and a second pixel driving electrode for driving the second pixel. For example, the first view angle is the wide view angle and the second view angle is the narrow view angle. In this case, the pixels of the wide view angle and the pixel of the narrow view angle are also independently driven by the pixel driving electrodes that are used exclusively. Thus, it becomes possible to switch the narrow vision display and the wide vision display.

The display device may be characterized in that the electrodes are constituted with a plurality of scanning electrodes and a plurality of signal electrodes being arranged in matrix; and the pixels are provided correspondingly at each node between the plurality of scanning electrodes and the plurality of signal electrodes. This is a matrix-type display device such as an active matrix type and a passive matrix type. For example, regarding the active matrix type using TFT, the “scanning electrodes” herein include the gate lines and gate electrodes and, similarly, the “signal electrodes” herein include the data lines and source electrodes. The present invention can be applied not only to the matrix type, but also to the segment type.

The display device may be characterized in that switching devices are provided at each node between the plurality of scanning electrodes and the plurality of signal electrodes, and connected to the pixels. This is an active-matrix-type display device. Examples of the switching device are TFT, TFD, MIM, etc.

The display device may be characterized in that either one of the plurality of scanning electrodes and the plurality of signal electrodes is divided into the first pixel driving electrode and the second pixel driving electrode. In this state, the other one of the plurality of scanning electrodes and the plurality of the signal electrodes serve as common electrodes for the first pixel and the second pixel.

The display device may be characterized in that a main pixel is constituted with at least one each of the first pixel having a first view angle and the second pixel having a second view angle which is different from the first view angle; and the first pixel and the second pixel belonging to the main pixel are connected to the same scanning electrode and to the signal electrodes that are different from each other, or connected to the scanning electrodes that are different from each other and to the same signal electrode. In this case, when the first pixel and the second pixel are connected to the same scanning electrode and to different signal electrodes, the scanning electrode becomes the common electrode, and the signal electrodes are divided into the first pixel driving electrode and the second pixel driving electrode. Meanwhile, when the first pixel and the second pixel are connected to the different scanning electrodes and to the same signal electrode, the scanning electrodes are divided into the first pixel driving electrode and the second pixel driving electrode, and the signal electrode becomes the common electrode.

The display device may be characterized in that the pixels comprise a liquid crystal layer, and light emitted from the pixels is light transmitted through the pixels; and a light-transmitting member is provided on a path of the light that transmits through the pixels for generating a difference of the first view angle and the second view angle. This is the transmission-type liquid crystal display device capable of switching the narrow view angle display and the wide view angle display.

The display device may be characterized in that the light-transmitting member comprises an uneven structure that includes a plane, and the difference of the first view angle and the second view angle is generated by a difference in the uneven structure. It is assumed that the light-transmitting member has a part with extensive unevenness and a part with slight unevenness. The light transmitted through the part with extensive unevenness is more scattered compared to the light passed through the part with slight unevenness, i.e. the view angle is expanded. Instead of the part with the extensive unevenness and the part with the slight unevenness, there may be provided a part with unevenness and a part without unevenness (that is, plane).

The display device may be characterized in that the uneven structure is a roughness of a surface. It is assumed that the light-transmitting member has a part with extremely rough surface and a part with slightly rough surface. The light transmitted through the part with extremely rough surface is more scattered compared to the light transmitted through the slightly rough surface, i.e. the view angle is expanded.

The display device may be characterized in that the uneven structure is a lens or a prism. With the lens or the prism, it is possible to expand or narrow the light by the design of the lens or the prism.

The display device may be characterized in that the light-transmitting member comprises a specific internal structure, and the difference of the first view angle and the second view angle is generated by a difference in the internal structure. The light-transmitting member described earlier has a specific feature in its external structure, however, it may have a specific feature in its internal structure as in this case (for example, refractive index).

The display device may be characterized in that the light-transmitting member is a color filter, and the internal structure is a grain diameter of a pigment. It is assumed that the color filter has a part with pigment of larger grain diameter and a part with a pigment of smaller grain diameter. In general, the light transmitted through a part with a pigment of larger diameter is more scattered compared to the light transmitted through a part with a pigment of smaller grain diameter. That is, the view angle is expanded.

The display unit according to the present invention comprises the display device of the present invention; a light source for emitting the light that transmits through the pixels of the display device; and a beam direction restricting device that improves directivity of the light emitted from the light source. The display unit of the present invention comprises the display device of the present invention. Thus, the pixels of each view angle can be driven independently, so that it is possible to switch the display in accordance with the view angles.

Use of the light source with narrow emission angle for the light source of the display device described above makes it possible to narrow the range of display angles at the time of narrow vision display. At the time of wide vision display, the light emitted from the light source is scattered through the high scattering region so as to expand the light emitted from the display device. Therefore, the difference in the range of the display angles between the wide view field and the narrow view field can be made more extensive by using the light source with high directivity.

Further, the present invention can be structured as follows.

The display device according to the present invention is distinctive in respect that at least a part of the regions has a different scattering power from that of the other region, and each region can be driven independently. With the structure of the present invention, the regions with different scattering powers are formed within the display device, so that the phase-difference-control liquid crystal device is unnecessary. Thus, there is no increase in the thickness of the entire display device, and it is possible to switch the wide vision display and the narrow vision display without utilizing the phase difference. Specific examples thereof will be presented in the followings. “Scattering power” herein means the scattering degree of the light. The high the scattering power, the larger the light can be scattered, and the lower the scattering power, the smaller the light can be scattered.

(1) The display device may be characterized in that at least a part of the regions has a different scattering power from that of the other region, and each region can be driven independently.

(2) In the structure described in (1), the display device may be characterized in that each pixel of the display device is constituted with two or more sub-pixels with different scattering powers, and each of the sub-pixels can be driven independently.

(3) In the structure described in (1) and (2), the display device may be characterized in that, as a means for achieving the different scattering powers, an uneven structure is provided on a part of at least either one of the substrates used in the display device.

(4) In the structure described in (1) and (2), the display device may be characterized in that, as a means for achieving the different scattering powers, two kinds of thin films with different scattering powers are provided on a part of at least either one of the substrates used in the display device.

(5) In the structure described in (1) and (2), the display device may be characterized in that, among a pair of transparent substrates used in the display device, a part of at least either one of the transparent substrates is roughened to form the regions with different scattering powers, as a means for achieving the different scattering powers.

(6) In the structure described in (1) and (2), the display device may be characterized in that, among a pair of transparent substrates used in the display device, a lens or a prism is provided on a part of at least either one of the transparent substrates to form the regions with different scattering powers, as a means for achieving the different scattering powers.

(7) It may be a display unit that is characterized in that, in the structure described in (1)-(6), a highly directive light source is disposed behind the display device.

(8) The display unit may be characterized in that, in the structure described in (1)-(7), the highly directive light source comprises, over the light source, a beam direction restricting device in which a transparent region that transmits the light and an absorbing region that absorbs the light are repeatedly formed.

In the present invention, a plurality of the pixels are classified into a plurality of kinds in accordance with the view angles thereof, and a plurality of electrodes are classified into the kinds of the pixels. Thus, the pixels of each view angle can be driven independently. Therefore, it is possible to switch the displays with high qualities according to the view angles without increasing the entire thickness.

In other words, in the present invention, at least a part of the region has a different scattering power from that of the other region, and each region can be driven independently. Therefore, there is no increase in the thickness as the entire display device, and it becomes possible to switch the wide view filed display and the narrow vision display without utilizing the phase difference. Furthermore, it is possible to provide a display unit that exhibits a sufficient shielding performance in the narrow vision display.

### BRIEF DESCRIPTION OF THE DRAWINGS

FIG. 1 shows plan views of a first embodiment of a display device according to the present invention, in which FIG. 1A is a first example and FIG. 1B is a second example;

FIG. 2 shows sectional views for illustrating the actions of the display device shown in FIG. 1, in which FIG. 2A shows no display state, FIG. 2B shows the narrow vision display, and FIG. 2C shows the wide vision display;

FIG. 3 is a sectional view for showing a concretive example of the display device shown in FIG. 1 and a first embodiment of the display unit according to the present invention;

FIG. 4 shows sectional views for illustrating the actions of the display device shown in FIG. 3, in which FIG. 4A shows the narrow vision display, and FIG. 4B shows the wide vision display;

FIG. 5 is a plan view for showing a second embodiment of the display device according to the present invention;

FIG. 6 shows plan views of concretive examples of the display device shown in FIG. 5, in which FIG. 6A is a first example and FIG. 6B is a second example;

FIG. 7 shows sectional views for showing an example of the display device shown in FIG. 6 in more concretive way, in which FIG. 7A is a longitudinal section taken along the line I-I in FIG. 6, and FIG. 7B is a longitudinal section taken along the line II-II in FIG. 6;

FIG. 8 shows sectional views for showing a third embodiment of the display device according to the present invention, in which FIG. 8A is a longitudinal section taken along the line I-I in FIG. 6, and FIG. 8B is a longitudinal section taken along the line II-II in FIG. 6;

FIG. 9 shows sectional views for showing a fourth embodiment of the display device according to the present invention, in which FIG. 9A is a longitudinal section taken along the line I-I in FIG. 6, and FIG. 9B is a longitudinal section taken along the line II-II in FIG. 6;

FIG. 10 shows sectional views for showing a fifth embodiment of the display device according to the present invention, in which FIG. 10A is a longitudinal section taken along the line I-I in FIG. 6, and FIG. 10B is a longitudinal section taken along the line II-II in FIG. 6; and

FIG. 11 is a sectional view for showing the second embodiment of the display unit according to the present invention.

### DETAILED DESCRIPTION OF THE PREFERRED EMBODIMENTS

In the followings, embodiments of the present invention will be described by referring to the accompanying drawings. It is noted that only a part of the display device is schematically illustrated in the drawings and there are proper spaces provided between the layers of the display device for better understanding, even though the display devices in practice are staked with almost no space provided therebetween.

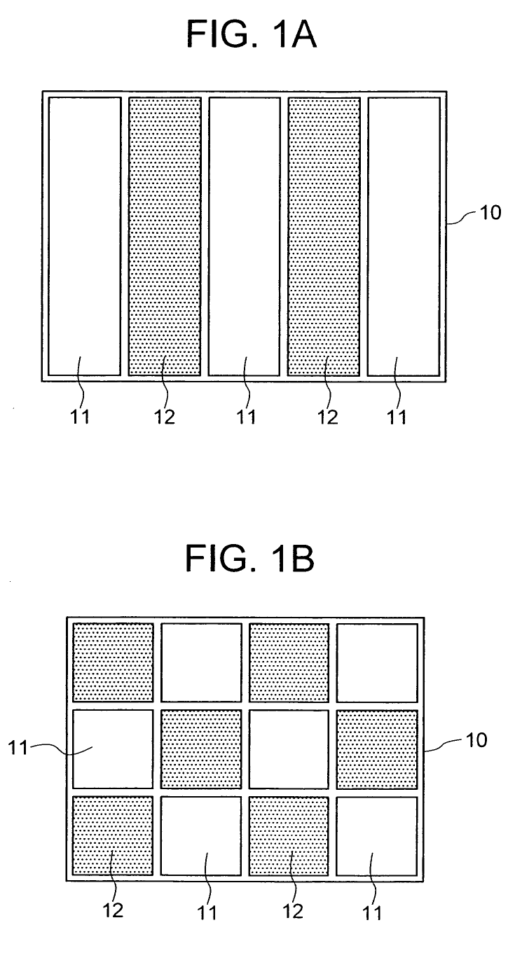

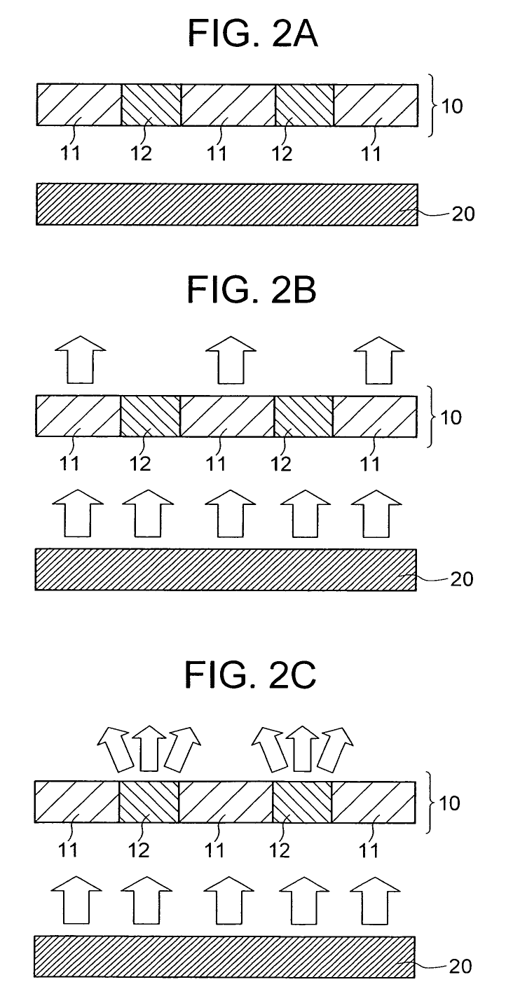

FIG. 1 shows plan views of a first embodiment of the display device according to the present invention, in which FIG. 1A is a first example and FIG. 1B is a second example. FIG. 2 shows sectional views for illustrating the actions of the display device shown in FIG. 1, in which FIG. 2A shows no display state, FIG. 2B shows the narrow vision display, and FIG. 2C shows the wide vision display. Explanations will be provided hereinafter by referring to those drawings.

A display device 10 is divided into a low scattering region 11 and a high scattering region 12. The display device 10 is placed over a backlight 20, and the display device 10 and the backlight 20 together constitute a display unit. The low scattering region 11 and the high scattering region 12 can be driven separately from each other. Each of the low scattering region 11 and the high scattering region 12 is constituted with a single pixel or two or more pixels.

Now, action of the display device 10 will be described. At first, the narrow vision display will be described. FIG. 2B schematically illustrates the state when the light emitted from the backlight 20 propagates to an observer, in the case of the narrow vision display. As shown in the drawing, the display device 10 is driven in such a manner that the light emitted from the backlight 20 transmits only through the low scattering region 11 but does not transmit through the high scattering region 12. The light emitted from the backlight 20 hardly scatters even if it makes incident on the low scattering region 11. Therefore, the directivity of the light emitted from the display device 10, i.e. the spread of the light, stays as it is (stays as the directivity of the light emitted from the backlight 20).

Next, the wide vision display will be described. FIG. 2C schematically illustrates the state when the light emitted from the backlight 20 propagates to an observer, in the case of the wide vision display. As shown in the drawing, the display device 10 is driven in such a manner that the light emitted from the backlight 20 transmits only through the high scattering region 12 but does not transmit through the low scattering region 11. The light emitted from the backlight 20 makes incident on the high scattering region 12. The incident light is scattered in the high scattering region 12, which spreads to wide angles to be a broad emission light. Therefore, the spread of the light emitted from the display device 10, i.e. the directivity of the light, becomes broader compared to the light emitted from the backlight 20.

As described above, when only the low scattering region 11 is driven, the distribution characteristic of the light passing through the display device 10 stay as that of the light emitted from the backlight 20. Thus, the narrow vision display can be achieved. Further, when only the high scattering region 12 is driven, the distribution characteristic of the light passing through the display device 10 becomes broader, so that the wide vision display can be achieved. Furthermore, the distribution characteristic of the light emitted from the backlight 20 is preferable to be as narrow as possible in order to perform the narrow vision display with high quality.

Further, when the low scattering region 11 and the high scattering region 12 are driven simultaneously, the distribution characteristics of the both are leveled off. Thus, the distribution characteristic become broader than that of the backlight 20, so that the wide vision display with high luminance can be achieved.

Furthermore, the low scattering region 11 and the high scattering region 12 are not limited to be in the longitudinal stripe form as shown in FIG. 1A. Needles to say, the same effect can be achieved with a lateral stripe form and a checkerwise form that is shown in FIG. 1B. Moreover, the occupying ratio of the low scattering region 11 and the high scattering region 12 is not limited to be 50% each. The ratio may be changed by considering the directivity of the backlight 20.

Based on the facts described above, it is possible in the display device 10 of the embodiment to switch the wide vision display and narrow vision display through selectively driving either the high scattering region 12 or the low scattering region 11, without controlling the gradation mode or the phase difference. In addition, it is unnecessary to add the phase-difference-control liquid crystal panel, so that there is no increase in the thickness of the display device 10.

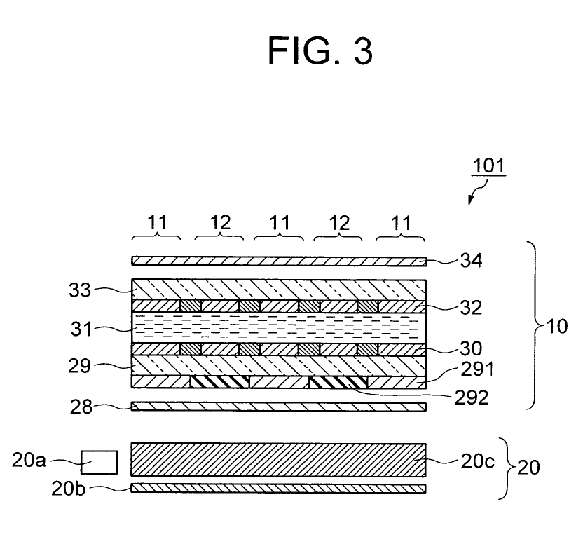

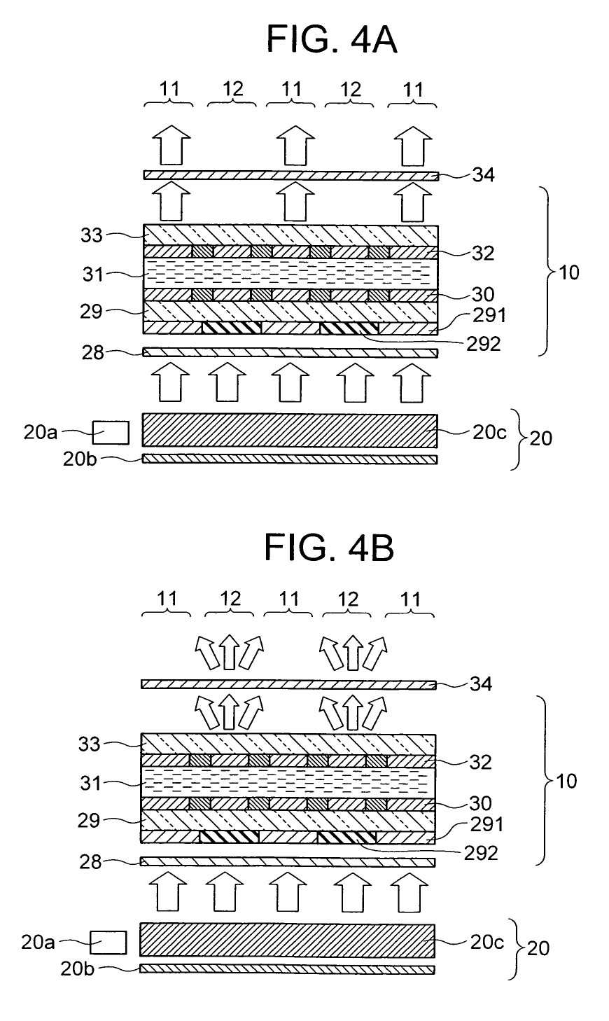

FIG. 3 is a sectional view for showing a concretive example of the display device shown in FIG. 1 and a first embodiment of the display device according to the present invention. FIG. 4 shows sectional views for illustrating the actions of the display device shown in FIG. 3, in which FIG. 4A shows the narrow vision display, and FIG. 4B shows the wide vision display. Explanations will be provided hereinafter by referring to those drawings.

A display unit 101 comprises the display device 10 and the backlight 20. The display unit 101 has a structure in which a polarizing plate 28, a transparent substrate 29, a transparent electrode 30, a liquid crystal layer 31, a transparent electrode 32, a transparent substrate 33, and a polarizing plate 34 are stacked in order on the backlight 20. The transparent electrodes 30 and 32 are patterned for each pixel, so that each pattern region can be driven separately. Further, on the back-face side of the transparent substrate 29, there are alternately formed a low scattering pattern 291 and a high scattering pattern 292, which are superimposed over the pattern regions of the transparent electrodes 30 and 32, respectively. With this, there is obtained the display device 10 in which the low scattering region 11 and the high scattering region 12 are formed alternately. Furthermore, since orientation processing is performed on the liquid crystal layer 31 by forming an orientation film (not shown) on the transparent electrodes 30 and 32, liquid crystal molecules (not shown) are orientated thereon.

Further, a light source 20a is provided at the side face of the backlight 20, and the light emitted from the light source 20a is directed to make incident on a light-guide plate 20c. The light-guide plate 20c emits the light from the entire surface thereof through refracting and reflecting the incident light by a plurality of prisms (not shown) provided within the surface of the light-guide plate 20c and a reflecting plate 20b provided at the rear face. The emission light exhibits the distribution that is spread to the wide angle with respect to a direction of the normal the plane (in the upper direction in FIG. 1).

It is noted here that the spread of the light emitted from the backlight is preferable to be narrowed as much as possible. Further, although the embodiment uses a side-light type backlight as the backlight 20, it is not limited to that. It may a direct-type backlight in which a fluorescent tube is placed right below the display device 10.

The low scattering region 11 and the high scattering region 12 of the display device 10 are formed in the following manner. First, resist is applied to the back face (the surface on the backlight side) of the transparent substrate 29, and the resist is then exposed to have the resist remained only on the part to be the low scattering pattern 291. Then, the back face of the transparent substrate 29 to be the part that becomes the high scattering pattern 292 is formed into a frosted glass by roughening it with sandblasting. Then, the resist is peeled off. With this, the back face of the transparent substrate 29 can be divided into the low scattering pattern 291 and the high scattering pattern 292.

The high scattering pattern 292 may be formed when the transparent substrate 29 is still by itself, or after the polarizing plates 28, 34 with liquid crystals injected therein are laminated between the transparent plates 29, 33. Furthermore, although the high scattering pattern 291 is formed in the transparent substrate 29 in FIG. 3, it is not limited to that. The high scattering pattern may be formed in the transparent substrate 33.

Next, general action of the display device 10 will be described. In the display device 10, the liquid crystal layer 31 is sandwiched between the transparent substrate 29 and the transparent substrate 33. On the liquid crystal layer 31 side of the transparent substrates 29 and 33, there are formed the orientation film (not shown) for determining the orientation direction of the liquid crystals and the transparent electrodes 30, 32 for driving the low scattering region 11 and the high scattering region 12 separately from each other. Further, absorbing-type polarizing plates 28 and 34 are laminated on the surface (on the opposite side of the liquid crystal layer 31) of the transparent substrates 29, 33.

When the voltage is applied to the liquid crystal layer 31, the orientation of the liquid crystal molecules (not shown) in the display device 10 is changed. The polarization state of the light transmitted through the polarizing plate 34 changes due to the birefringent effect and the optical activity caused by the changes in the orientation of the liquid crystal molecules. Thus, the amount of the light to be transmitting through the polarizing plate 34 is changed. Through adjusting the amount of the light emitted from each pixel by utilizing this phenomenon, shading is achieved in the display.

The view angle property of the display device 10 depends on the liquid crystal display mode of the liquid crystal layer 31. In order to achieve the wide vision state and the narrow vision state as in the embodiment, it is preferable to employ the wide vision system for the liquid crystal display mode. Specific example are: lateral electric field systems such as the in-plane switching system (IPS system) and the fringe field switching system (FFS system), which activate the liquid crystal molecules within the liquid crystal display device by utilizing the lateral electric field; vertical orientation systems such as the vertical alignment system (VA system), the domain-patterned vertical alignment system (PVA system), the advanced super V system (ASV system), which utilize the vertical orientations; and a film compensating system that performs optical compensation by using anisotropic optical films.

Now, actions of the narrow vision display and the wide vision display of the display device 10 will be described. At first, the action of the narrow vision display will be described. FIG. 4A schematically illustrates the diffusing state of the light that is emitted from the backlight 20 and propagated to an observer, in the case of the narrow vision display. The narrow vision display uses only the low scattering region 11 as the display region, and the high scattering region 12 remains in dark state. With this, the light emitted from the backlight 20 transmits through the low scattering pattern 291 of the transparent substrate 29. Unlike the high scattering pattern 292, the low scattering pattern 291 is not made into a frosted glass. Thus, the incident light transmits therethrough with almost no scattering. The light transmitted through the low scattering pattern 291 transmits through the transparent substrate 29, the transparent electrode 30, the liquid crystal layer 31, the transparent electrode 32, the transparent substrate 33, and the polarizing plate 34. The light is emitted with hardly any scattering when passing through those members. Therefore, the directivity of the light emitted from the display device 10, i.e. the diffusing degree of the light, stays as it is when the light is emitted from the backlight 20, thereby providing the narrow vision display.

Next, the action of the wide vision display will be described. Inversely from the above, the liquid crystal layer 31 is activated in such a manner that the light transmits only through the high scattering region 12 but not through the low scattering region 11, as shown in FIG. 4B. When the light emitted from the backlight 20 makes incident on the high scattering pattern 292 of the transparent substrate 29, it scatters because the high scattering pattern 292 is made into a frosted glass. The light transmitted through the high scattering pattern 292 transmits through the transparent substrate 29, the transparent electrode 30, the liquid crystal layer 31, the transparent electrode 32, the transparent substrate 33, and the polarizing plate 34. The light is emitted with hardly any scattering when passing through those members. Therefore, the spread of the light emitted from the display device 10 stays as it is, having the characteristic when it is scattered in the high scattering pattern 292. Accordingly, the light comes to have a broader directivity compared to the light emitted from the backlight 20, thereby providing the high vision display.

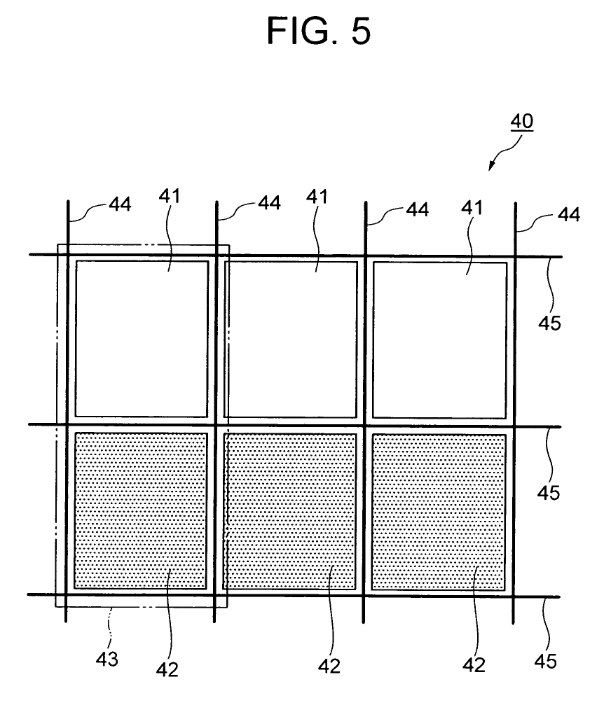

FIG. 5 is a plan view for showing a second embodiment of the display device according to the present invention. Explanations will be provided hereinafter by referring to the drawing.

The display device 40 according to this embodiment is characterized to have at least two sub-pixels 41, 42 with different scattering powers, in which each of the sub-pixels 41 and 42 can be driven independently. A single main pixel 43 is constituted with the two sub-pixels 41 and 42. A switching device (not shown) is formed in each of the sub-pixels 41 and 42, so that the sub-pixels 41 and 42 can be independently driven through data lines 41 and gate lines 45. The sub-pixel 41 is a low scattering region with which the light emitted from the backlight (not shown) is not scattered, so that the spread of the light emitted from the backlight is not changed therethrough. Further, the sub-pixel 42 is a high scattering region that scatters the light emitted from the backlight. Thus, the spread of the light emitted from the sub-pixel 42 becomes broader than the spread of the light emitted from the backlight.

Therefore, when only the sub-pixel 42 is used as the display pixel, the distribution characteristic of the light transmitted through the display device 40 becomes broad, thereby enabling the wide vision display. Meanwhile, when the sub-pixel 41 is used as the display pixel, the distribution characteristic of the light transmitted through the display device 40 stays as it is (stays as the orientation characteristic of the light emitted from the backlight), thereby enabling the narrow vision display. Regarding the distribution characteristic of the light emitted from the backlight, it is preferable to be as narrow as possible.

With the display device 40, it is possible to switch the wide vision display and the narrow vision display through selectively driving either the sub-pixel 41 or the sub-pixel 42 with different scattering powers, without controlling the gradation mode or the phase difference. In addition, it is unnecessary to add the phase-difference-control liquid crystal panel, so that there is no increase in the thickness of the display device 40. Furthermore, it is also possible at the time of narrow vision display to perform wide vision display in a part of the display device 40 or to display information such as letters only in the oblique directions, through partially driving the sub-pixel 42.

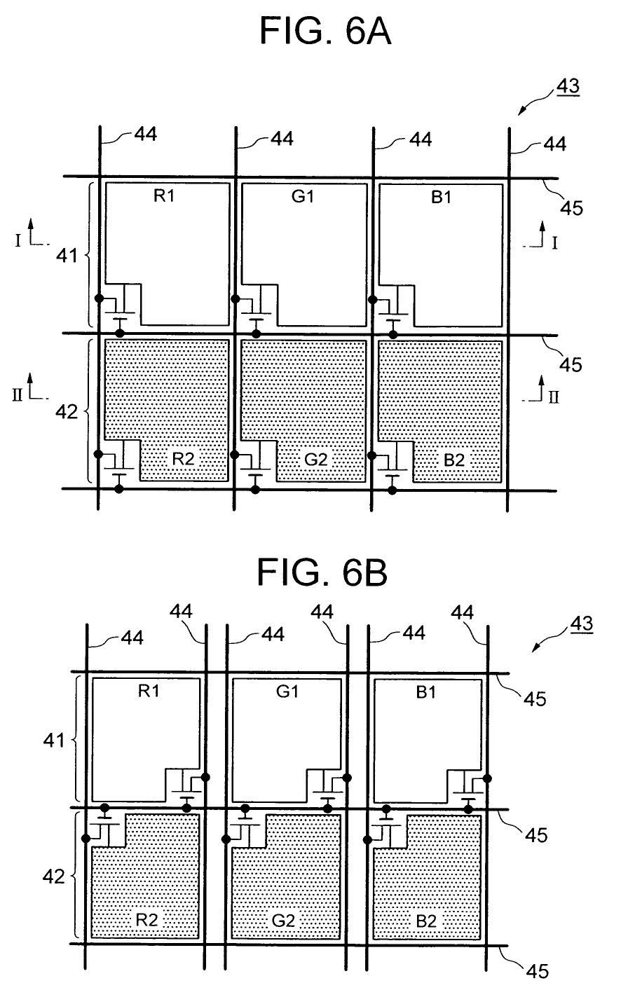

FIG. 6 shows plan views of concretive examples of the display device shown in FIG. 5, in which FIG. 6A is a first example and FIG. 6B is a second example. Explanations will be provided hereinafter by referring to the drawing.

FIG. 6A is an enlarged plan view of one main pixel 43 shown in FIG. 5. The main pixel 43 is constituted with the sub-pixels 41 and 42. The sub-pixel 41 is constituted with a pixel R1 for displaying red, a pixel G1 for displaying green, and a pixel B1 for displaying blue, while the sub-pixel 42 is constituted with a pixel R2 for displaying red, a pixel G2 for displaying green, and a pixel B2 for displaying blue. The switching device is formed in each of the pixels R1, G1, B1, R2, G2, B2, so that each of the pixels can be driven independently. The pixels R1, G1, B1 are the low scattering regions with which the light emitted form the backlight is not scattered, and the pixels R2, G2, B2 are the high scattering regions with which the light emitted form the backlight is scattered.

In FIG. 6A, TFT is assumed to be the switching device. However, it is not limited to that. It may be a diode-type switching device such as MIM, as long as the pixels of each color can be driven independently. Further, the present invention can be applied not only to the active-matrix type as in the embodiment, but also to a passive-matrix type.

Furthermore, in FIG. 6A, the data lines 44 are used in common, and the gate lines 45 are allotted to each of the sub-pixels 41, 42, so that each of the sub-pixels 41, 42 can be driven independently. However, it is not limited to that. As shown in FIG. 6B, the gate lines 45 may be used in common, and the data lines 44 are allotted to each of the sub-pixels 41, 42, so that each of the sub-pixels 41, 42 can be driven independently.

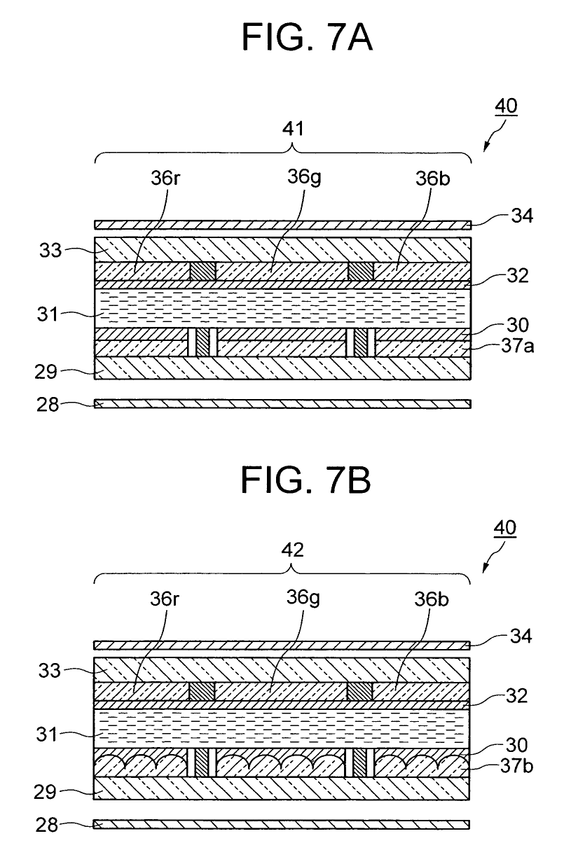

FIG. 7 shows sectional views for showing an example of the display device shown in FIG. 6 in more concretive way, in which FIG. 7A is a longitudinal section taken along the line I-I in FIG. 6 and FIG. 7B is a longitudinal section taken along the line II-II in FIG. 6. Explanations will be provided hereinafter by referring to FIG. 5-FIG. 7. Explanations of the components in FIG. 7, which are the same as those in FIG. 3, will be omitted by applying the same reference numerals thereto.

FIG. 7A shows the sectional view of the pixels R1, G1, B1 of each color, and FIG. 7B shows the sectional view of the pixels R2, G2, B2 of each color. In the sectional view shown in FIG. 7A, there is shown a structure in which the polarizing plate 28, the transparent substrate 29, a transparent layer 37a, the transparent electrode 30, the liquid crystal layer 31, the transparent electrode 32, color filter layers 36r, 36g, 36b, the transparent substrate 33, and the polarizing plate 34 are stacked in this order from the bottom when looking at the drawing. The color filter layers 36r, 36g, 36b transmit only the light of red, green, and blue, respectively. The orientation film for orientating the liquid crystals and the switching devices are not illustrated for easy understanding.

Further, in FIG. 7B, a transparent uneven structure 37b is formed on the transparent substrate 29, and the transparent electrode 30 is formed thereon. The uneven structure 37b forms a random structure over the entire sub-pixel 42. Because the uneven structure 37b is formed within the sub-pixel 37 and there is a difference in the refractive indexes in the uneven interface, the light transmitting through the uneven structure 37b is more scattered compared to the light emitting through the sub-pixel 41 having no uneven structure 37b.

Like the internal reflecting plate formed in a reflective-type liquid crystal device or a semitransparent liquid crystal device, the uneven structure 37b is formed only in the sub-pixel 42 of the high scattering region, through forming a transparent layer within the sub-pixels 41, 42, applying resist thereon, performing pattern exposure, and peeling off the resist. Thereafter, unlike the case of the reflective-type liquid crystal device or the semitransparent liquid crystal device, no metal such as aluminum is formed on the uneven structure 37, but a transparent electrode such as an ITO film is formed on the transparent layer. By forming the transparent electrode 30 on the uneven structure 37b in this manner, the light from the backlight can be transmitted, and the light is scattered when transmitting through the uneven structure 37b whose surface is in an uneven state.

Therefore, it becomes possible to change the spread of the incident light from the backlight when using the pixels R1, G1, B1 for display and when using the pixels R2, G2, B2 for display. That is, by driving the pixels R1, G1, B1 for the narrow vision display and the pixels R2, G2, B2 for the wide vision display, respectively, the narrow vision display and the wide vision display can be electrically switched in the display device 40.

In other words, the display device 40 is characterized to have the uneven structure 37b, as a means for achieving different scattering powers, in a part of at least either the transparent substrate 29 or the transparent substrate 33. Further, since the uneven structure 37b is formed within the display device 40, there is no increase in the thickness of the display device 40. Furthermore, although the uneven structure 37b is formed as a random structure herein, it is not limited to that. It may be in any forms as long as there is provided a different spread angle from that of the sub-pixel 41 in which the uneven structure is not formed.

It is noted here that the distribution characteristic of the light emitted from the backlight is preferable to be as narrow as possible. Furthermore, through partially driving the pixels R2, G2, B2 at the time of the narrow vision display, it becomes possible to perform wide vision display in a part of the display device 40 or to display information such as letters only in the oblique directions. Moreover, although the embodiment has been described by referring to the case of color display, it is not limited to that. Needless to say, the same effect can be achieved for monochrome display, when a single pixel is constituted with two or more sub-pixels, the sub-pixels have different scattering powers, and the sub-pixels can be driven independently.

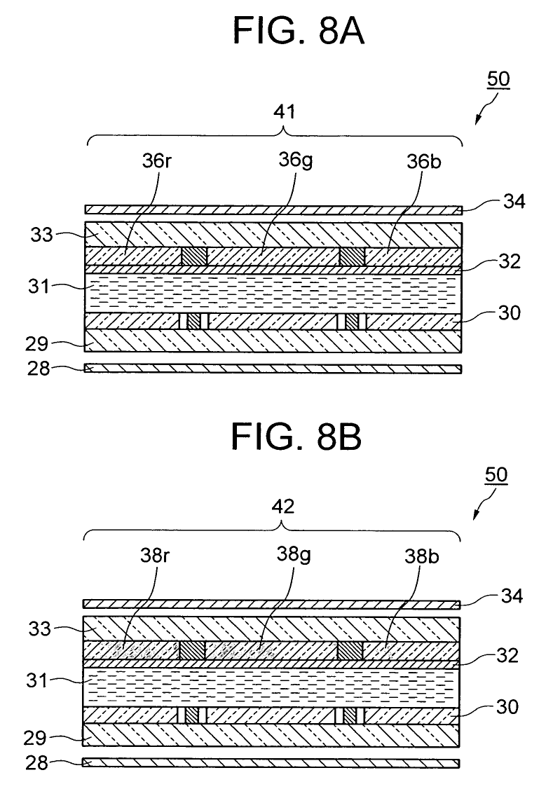

FIG. 8 shows sectional views for showing a third embodiment of the display device according to the present invention, in which FIG. 8A is a longitudinal section taken along the line I-I in FIG. 6 and FIG. 8B is a longitudinal section taken along the line II-II in FIG. 6. Explanations will be provided hereinafter by referring to the drawings. However, explanations of the same components as those in FIG. 7 will be omitted by applying the same reference numerals thereto.

The difference between the third embodiment and the second embodiment is that color filter layers 36r, 36g, 36b, and 38r, 38g, 38b having different scattering powers are used for each of the sub-pixels 41 and 42. For the color filter layers 36r, 36g, 36b of the sub-pixel 41 shown in FIG. 8A, used are the ones with pigments of small grain diameter. For the color filter layers 38r, 38g, 38b of the sub-pixel 42 shown in FIG. 8B, used are the ones with pigments of large grain diameter. The scattering powers can be changed for each of the sub-pixels 41, 42, through changing the grain diameter of the pigment for each of the sub-pixels 41, 42. In general, those with small grain diameter are low scattering, and the degree of scattering increases as the grain diameter becomes larger. Thus, it is possible to provide the sub-pixels 41, 42 with different scattering powers by forming the color filter layers 36r, 36g, 36b, and 38r, 38g, 38b using the pigment of different grain diameters.

Therefore, like the second embodiment, the narrow vision display and the wide vision display can be switched electrically through selectively displaying either the sub-pixel 41 or the sub-pixel 42. Further, since the difference of the scattering powers is provided within the display device 50, there is no increase in the thickness of the display device 50.

In this embodiment, the sub-pixels 41, 42 with different scattering powers are formed by utilizing the difference in the grain diameters of the pigments of the color filter layers 36r, 36g, 36b, and 38r, 38g, 38b. However, it is not limited to that. For example, stationary substances such as transparent spacer beads may be added to the liquid crystal layer 31 of the sub-pixel 42 as the high scattering region to provide different scattering powers.

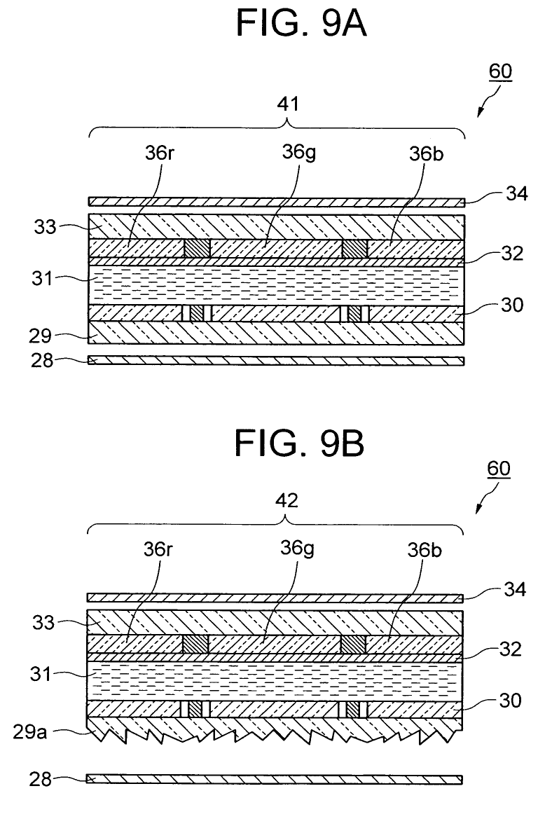

FIG. 9 shows sectional views for showing a fourth embodiment of the display device according to the present invention, in which FIG. 9A is a longitudinal section taken along the line I-I in FIG. 6 and FIG. 9B is a longitudinal section taken along the line II-II in FIG. 6. Explanations will be provided hereinafter by referring to the drawings. However, explanations of the same components as those in FIG. 7 will be omitted by applying the same reference numerals thereto.

The difference between the fourth embodiment and the second, third embodiments is the method for forming the sub-pixels 41, 42 having different scattering powers. The fourth embodiment is distinctive in respect that the high scattering region is formed by roughing a part of the surface of at least either the transparent substrate 29 or the transparent substrate 33 used as a pair in the display device 60. FIG. 9A shows the sub-pixel 41 of the low scattering region, and FIG. 9B shows the sub-pixel 42 of the high scattering region.

As a method for forming the sub-pixel 42, there is sandblasting. For example, resist is applied on the back face of the transparent substrate 29 (opposite side of the liquid crystal layer 31) before laminating the polarizing plates 28 and 34 thereto. Then, it is pattern-exposed to protect the region that is not to be roughened. Thereafter, abrasive grains are sprayed over the transparent substrate 29 by sandblasting to form a roughened transparent substrate 29a. With this, the sub-pixel 41 and the sub-pixel 42 can be formed into the structures having different scattering powers.

Therefore, as has been described above, the narrow vision display and the wide vision display can be switched electrically through selectively displaying either the sub-pixel 41 or the sub-pixel 42. Further, since the means for making a difference in the scattering powers is provided within the display device 60, there is no increase in the thickness of the display device 60.

In this embodiment, the back face of the transparent substrate 29 is roughened. However, it is not limited to that. For example, the same effects can also be achieved by roughening the back face side of the transparent substrate 33 in the same manner. Furthermore, haze of an antiglare layer formed on the surface of the polarizing plates 28 and 34 may be changed for the low scattering region and the high scattering region.

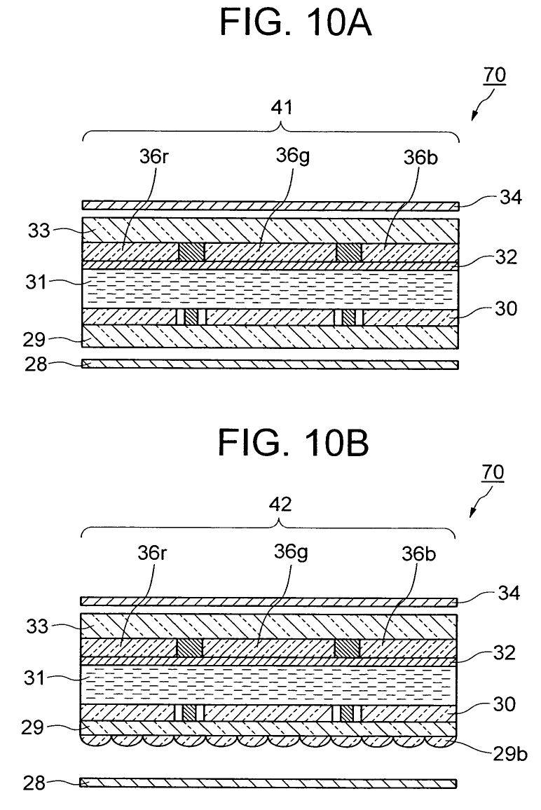

FIG. 10 shows sectional views for showing a fifth embodiment of the display device according to the present invention, in which FIG. 10A is a longitudinal section taken along the line I-I in FIG. 6 and FIG. 10B is a longitudinal section taken along the line II-II in FIG. 6. Explanations will be provided hereinafter by referring to the drawings. However, explanations of the same components as those in FIG. 7 will be omitted by applying the same reference numerals thereto.

This embodiment is distinctive in respect that a lens is provided in a part of at least either the transparent substrate 29 or the transparent substrate 33 used as a pair in the display device 70, as a method for forming the sub-pixels 41 and 42 with different scattering powers. FIG. 10A shows the sub-pixel 41 of the low scattering region, and FIG. 10B shows the sub-pixel 42 of the high scattering region. In this embodiment, a lens sheet 29b having a micro-lens array formed partially is laminated on the back face of the transparent substrate 29 (opposite side of the liquid crystal layer 31). At that time, the lens sheet 29b is placed over the transparent substrate 29 in such a manner that the micro-lens array comes on the sub-pixels 42 side.

Thereby, the light from the backlight is diffused at the sub-pixel 42 due to the lens effect of the micro-lens, so that the spread of the light emitted from the display device 70 becomes broad. With this, the sub-pixel 41 and the sub pixel 42 are formed to have the structures with different scattering powers.

Therefore, as has been described above, the narrow vision display and the wide vision display can be switched electrically through selectively displaying either the sub-pixel 41 or the sub-pixel 42. Further, since the means for making a difference in the scattering powers is provided within the display device 70, there is no increase in the thickness of the display device 70.

In this embodiment, the case of using the micro-lens has been described. However, it is not limited to that. For example, the same lens effect can also be achieved by using a prism array, and the spread of the incident light can be changed with that.

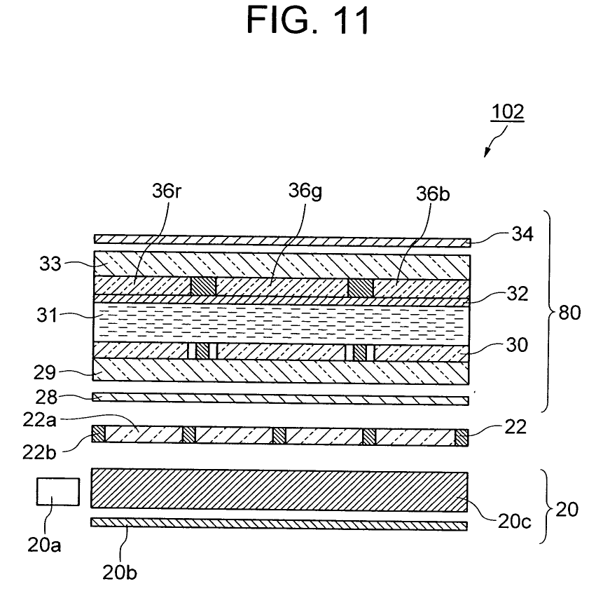

FIG. 11 is a sectional view for showing the second embodiment of the display unit according to the present invention. Explanations will be provided hereinafter by referring to the drawing. However, explanations of the same components as those in FIG. 3 will be omitted by applying the same reference numerals thereto.

This embodiment is distinctive in respect that a beam direction restricting device 22 for improving the directivity of the light is provided over the light source 20a so as to use the highly directive backlight 20 as the light source of the display device 80. The display device 80 is one of the display devices described in each of the embodiments. The beam direction restricting device 22 is a louver that is constituted by arranging a transparent region 22a for transmitting the light and a shielding region 22b for absorbing the light alternately in the direction along the surface of the beam direction restricting device 22. This type of beam direction restricting device is available on the market as an LCD film louver, for example.

Among the light emitted from the backlight 20, the light of a narrow angle is emitted after transmitting through the transparent region 22a. However, the light of a wide angle cannot transmit through the transparent region 22a, and it is absorbed to the absorbing region 22b. As a result, spread of the light emitted from the backlight 20 can be restricted. Further, the light of a wide angle is absorbed, so that a leakage of the light to the wide angle side at the time of the narrow vision display can be reduced. This provides a clear difference between the range of the display angles at the time of the narrow view field and other range, i.e. a clear difference between “a range capable of viewing the display” and “a range that is not capable of viewing the display”. Thus, the difference between the wide vision display and the narrow vision display becomes more evident, which provides such effect that switching of the display can be done more distinctly.

With the embodiment, it is possible to switch the wide vision display and the narrow vision display even though it maintains the same thickness as that of the conventional liquid crystal display device. Further, it is possible to improve the distinctiveness between the wide vision display and the narrow vision display, i.e. to improve the view angle controllability. Needless to say, the same effects can also be achieved by using the light source that has any kinds of directivity, since the directivity of the light source is controlled by the beam direction restricting device. The structures, action, and the effects of this embodiment, which are not mentioned herein, are the same as those of each embodiment described above.

The present invention has been described by referring to the preferred embodiments thereof. However, the display device and the display unit according to the present invention are not limited only to each of the embodiments described above. That is, it is intended to include within the range of the present invention a display device and a display unit which are obtained by applying various kinds of alterations and modifications to the structures of each embodiment.

What is claimed is:

1. A display device, comprising a plurality of pixels having different view angles and a plurality of electrodes for driving the each pixel independently.

2. The display device as claimed in claim 1, wherein:
the plurality of pixels comprise a first pixel having a first view angle and a second pixel having a second view angle which is different from the first view angle; and
the plurality of electrodes comprise a first pixel driving electrode for driving the first pixel and a second pixel driving electrode for driving the second pixel.

3. The display device as claimed in claim 2, wherein:
the electrodes are constituted with a plurality of scanning electrodes and a plurality of signal electrodes being arranged in matrix;
the pixels are provided correspondingly at each node between the plurality of scanning electrodes and the plurality of signal electrodes;
switching devices are provided at each node between the plurality of scanning electrodes and the plurality of signal electrodes, and connected to the pixels; and
either one of the plurality of scanning electrodes and the plurality of signal electrodes is divided into the first pixel driving electrode and the second pixel driving electrode.

4. The display device as claimed in claim 3, wherein:
a main pixel is constituted with at least one each of a first pixel having a first view angle and a second pixel having a second view angle which is different from the first view angle; and
the first pixel and the second pixel belonging to the main pixel are connected to the same scanning electrode and to the signal electrodes that are different from each other, or connected to the scanning electrodes that are different from each other and to the same signal electrode.

5. The display device as claimed in claim 2, wherein:
the pixels comprise a liquid crystal layer, and light emitted from the pixels is light transmitted through the pixels; and
a light-transmitting member is provided on a path of the light that transmits through the pixels for generating a difference of the first view angle and the second view angle.

6. The display device as claimed in claim 5, wherein the light-transmitting member comprises an uneven structure that includes a plane, and the difference of the first view angle and the second view angle is generated by a difference in the uneven structure.

7. The display device as claimed in claim 6, wherein the uneven structure is a roughness of a surface.

8. The display device as claimed in claim 6, wherein the uneven structure is a lens or a prism.

9. The display device as claimed in claim 5, wherein the light-transmitting member comprises a specific internal structure, and the difference of the first view angle and the second view angle is generated by a difference in the internal structure.

10. The display device as claimed in claim 9, wherein the light-transmitting member is a color filter, and the internal structure is a grain diameter of a pigment.

11. A display unit, comprising:
a display device as claimed in claim 1;
a light source for emitting the light that transmits through the pixels of the display device; and
a beam direction restricting device that improves directivity of the light emitted from the light source.
